(19) United States
(12) Patent Application Publication
(10) Pub. No.: US 2024/0145733 A1
(43) Pub. Date: May 2, 2024

(54) CATALYST FOR OER/ORR AND METHODS OF PREPARING THE SAME

(71) Applicant: NATIONAL CHENG KUNG UNIVERSITY, Tainan City (TW)

(72) Inventors: Jyh-Ming TING, Tainan City (TW); Kai-Wei LIN, Tainan City (TW)

(21) Appl. No.: 18/054,480

(22) Filed: Nov. 10, 2022

(30) Foreign Application Priority Data
Nov. 2, 2022 (TW) 111141854

(51) Int. Cl. H01M 4/90; C25B 11/091; D01D 1/02; D01D 5/00; D01F 9/08; H01M 4/86; H01M 4/96

(52) U.S. Cl. CPC H01M 4/9016; C25B 11/091; D01D 1/02; D01D 5/0038; D01F 9/08; H01M 4/8657; H01M 4/9091; H01M 4/96; H01M 12/06

(57) ABSTRACT

Provided a catalyst for OER/ORR, including: an alloy oxide core having a particle size of 30 to 40 nm; and a carbon layer having a thickness of 1 to 7 nm, which is coated on a surface of the alloy oxide core, wherein the alloy oxide is a ternary to quinary alloy oxide, and the metal element contained in the alloy oxide is a transition metal element. Also provided is a method for preparing catalysts for OER/ORR by an electrospinning process. Accordingly, the prepared catalyst has excellent OER and ORR characteristics.

### BACKGROUND

### 1. Technical Field

The present disclosure relates to a catalyst, and particularly to a catalyst for OER/ORR and methods of preparing it.

### 2. Description of Relevant Art

Recently, it has developed a method to prepare catalyst for increasing its high catalytic activity of oxygen reduction reaction (ORR) by using high precision device, noble metal or carbon materials, as well as an approach to prepare the catalyst for enhancing oxygen evolution reaction (OER) by using transition metal elements in multi-component alloy oxide.

However, production process of the high precision device takes a long time, and the price of the noble metal is expensive and difficult to obtain relatively. In addition, ORR activity of the catalyst usually decreases with the increase of the OER activity, which makes it difficult to improve the ORR and OER activities at the same time. Production process of the carbon materials of metal-organic framework (MOFs), ultrathin nano-carbon sheets, two-dimensional porous carbon materials, and three-dimensional graphene are complicated and time consuming.

Accordingly, the present disclosure provides a catalyst having reduced particle size and increased surface area, while maintaining a structure comprising alloy oxide core and carbon layer-coating surface and the method of preparing thereof at the same time, to obtain optimal dual-function activities of OER/ORR.

### SUMMARY

The present disclosure provides a catalyst for oxygen evolution reaction/oxygen reduction reaction (OER/ORR), including: an alloy oxide core having a particle size of 30 to 40 nm; and a carbon layer having a thickness of 1 to 7 nm, which is coated on surface of the alloy oxide core, wherein the alloy oxide is a ternary, quaternary and quinary alloy oxide, and the alloy oxide contains transition metal element(s).

In a specific embodiment of the present disclosure, the aforementioned catalyst has a surface area of 6500 to 9500 nm², for example, 6500, 7000, 7500, 7550, 7600, 7650, 7700, 7750, 7800, 7850, 7900, 7950, 8000, 8500, or 9500 nm². As mentioned above, the surface area of the aforementioned catalyst may be, for example, 7000 to 8500 or 7500 to 8000 nm².

In one embodiment of the present disclosure, the aforementioned ternary to quinary alloy oxide may be an alloy oxide represented by formula (I), and formula (I) is CoMnNi.

In one embodiment of the present disclosure, in the formula (I) described above, the molar ratio of Co: Mn: Ni may be 1 to 2:1 to 2:1 to 2, for example, 2:1:1, 1:2:1, or 1:1:2.

In one embodiment of the present disclosure, the aforementioned ternary to quinary alloy oxide may be an alloy oxide represented by formula (II), and formula (II) is CoMnNiM¹, wherein M¹ may be selected from a group consisting of Fe, Cr, and Cu, or may be selected from a group consisting of Fe, Cr, Cu, and Ti.

In one embodiment of the present disclosure, in the formula (II) described above, the molar ratio of Co: Mn: Ni: M¹ may be 1 to 2:1 to 2:1 to 2:1 to 2, for example, 2:1:1:1, 1:2:1:1, 1:1:2:1, 1:1:1:2, or 1:1:1:1.

In one embodiment of the present disclosure, the aforementioned ternary to quinary alloy oxide may be an alloy oxide represented by formula (III), and formula (III) is CoMnNiM²M³, wherein any one of the M² and M³ may be selected from a group consisting of Fe, Cr, and Cu, or may be selected from a group consisting of Fe, Cr, Cu, and Ti, and M² and M³ are different from each other.

In one embodiment of the present disclosure, the formula (III) described above, the molar ratio of Co:Mn:Ni:M²:M³ may be 1 to 2:1 to 2:1 to 2:1 to 2:1 to 2, for example, 2:1:1:1:1, 1:2:1:1:1, 1:1:2:1:1, 1:1:1:2:1, 1:1:1:1:2, or 1:1:1:1:1.

In one embodiment of the present disclosure, the aforementioned ternary to quinary alloy oxide may be, for example, CoMnNi, CoMnNiFe, CoMnNiCr, CoMnNiCu, CoMnNiTi, or CoMnNiFeCr, but the present disclosure is not limited to such specific examples.

In one embodiment of the present disclosure, a molar ratio of the CoMnNi of the aforementioned alloy oxide core to the C (carbon) of the carbon layer may be 90:10 to 60:40, for example, 90:10, 85:15, 82:18, 80:20, 77:23, 75:25, 72:28, 70:30, 65:35, or 60:40.

The present disclosure further provides a method of preparing a catalyst for OER/ORR, including: mixing and stirring three to five different metal sources and a surfactant in water to form a mixture; oxidizing the mixture in an air atmosphere to obtain an alloy oxide; mixing and stirring the alloy oxide and an acrylic resin in a solvent to obtain an electrospinning precursor solution; subjecting the electrospinning precursor solution to an electrospinning process to obtain alloy oxide-containing nanofibers; and annealing the alloy oxide-containing nanofibers in an air atmosphere to obtain the catalyst.

In one embodiment of the present disclosure, after mixing and stirring the metal sources and a surfactant in the water, a precipitating agent such as ammonia or urea is added, and after heating, the mixture is obtained, which is then subjected to oxidation treatment.

In one embodiment of the present disclosure, the aforementioned surfactant may be cetyltrimethylammonium bromide; the aforementioned acrylic resin may be selected from a group consisting of polymethylmethacrylate, poly(ethyl methacrylate), and poly(butyl methacrylate), preferably polymethylmethacrylate; the aforementioned solvent may be dimethylformamide.

In one embodiment of the present disclosure, the step of the aforementioned oxidation treatment may be conducted under 450 to 550° C. for 1.5 to 2.5 hours (hrs). For example, 450, 460, 470, 480, 490, 500, 510, 520, 530, 540, or 550° C., and 1.5, 1.6, 1.7, 1.8, 1.9, 2.0, 2.1, 2.2, 2.3, 2.4, or 2.5 hrs; such as at 450 to 550° C. for 2 hrs, or at 500° C. for 2hrs.

In one embodiment of the present disclosure, the step of the aforementioned annealing treatment may be conducted at 420 to 480° C. for 1.5 to 2.5 hrs. For example, 420, 430, 440, 450, 460, 470, or 480° C., and 1.5, 1.6, 1.7, 1.8, 1.9, 2.0, 2.1, 2.2, 2.3, 2.4, or 2.5 hrs; such as at 430 to 470° C. for 2 hrs, or at 440 to 460° C. for 2hrs. It should be noted that if the step of the above-mentioned annealing treatment is conducted in an air atmosphere at an annealing temperature of exceeding 485° C., the carbon layer will form CO₂ due to high temperature, so that the alloy oxide core cannot be coated by the carbon layer.

In one embodiment of the present disclosure, the aforementioned metal sources comprise transition metal element(s), and the said transition metal element(s) may be selected from a group consisting of Co, Mn, Ni, Fe, Cr, Cu, and Ti, preferably may be selected from a group consisting of Co, Mn, Ni, Fe, Cr, and Cu, more preferably selected from a group consisting of Co, Mn, Ni, Fe, and Cr. In one embodiment, the aforementioned metal source may be salt of the transition metal element(s) that can dissolve in the water, such as nitrate or hydrochloride of the transition metal element(s), for example, said salt may be Co(NO₃)₂·6H₂O, Mn(NO₃)₂·4H₂O, Ni(NO₃)₂·6H₂O, Fe(NO₃)₃·9H₂O, Cr(NO₃)₂·9H₂O, Cu(NO₃)₂·2.5H₂O, and TiCl₃.

In one embodiment of the present disclosure, the aforementioned electrospinning process may be conducted using electrospinning equipment, and the aforementioned electrospinning processing may be conducted under the process conditions of 15 kV applied voltage, 2.5 ml/hr flow rate of supplied electrospinning precursor solution, 10 cm working distance between needle head and plate, and 22 G needle head.

In one embodiment of the present disclosure, the present disclosure adopts hydrothermal method for material synthesis, which may at least based on three transition metal elements, cobalt (Co), manganese (Mn), and nickel (Ni), and may be further added with transition metal element(s) of iron (Fe), chromium (Cr), copper (Cu), or titanium (Ti), etc., from which elements in different amounts or proportions may be selected to synthesize the spinel structure of high-entropy oxide. Because the high-entropy oxide has variable valence state and special crystal structure, it is beneficial to reduce the difference of the reactive overpotential of OER/ORR. In addition, in the process of conducting ORR, oxygen molecules will be absorbed and dissociated on the surface of the catalyst. However, the spinel oxide has a relative low conductivity leading its ORR activity to be barely enhance Therefore, in order to further improve the catalytic activity of the ORR, the present disclosure also mixs the catalyst with acrylic resin and for electrospinning approach, and add carbon elements into oxide catalyst through simple processing to synthesize carbon-containing high-entropy oxide. Moreover, the micro-scale oxide particles are smashed into nano level through the electrospinning approach, thereby increasing the surface area and conductivity, and effectively increasing the dual-functional performance of OER/ORR.

As described above, one of the purposes of the present disclosure is to reduce the particle size and to increase surface area of the catalyst by electrospinning process, and enhance the activity of OER/ORR dual-function catalysts. In addition, one of the other purposes of the present disclosure is to utilize the method of oxidation treatment before conducting the electrospinning process, allowing the catalysts to have more optimal dual-function activity of OER/ORR. Beneficially, the present disclosure conducts the low-temperature annealing process at the annealing temperature lower than 450° C. in the air atmosphere, which can form a catalyst structure with alloy oxide core-containing and carbon layer that coating on surface of the core, while the catalyst has an excellent dual-function activities of OER/ORR. Further, beneficially, the present disclosure uses the catalyst, which is obtained by a simple approach of electrospinning process, can apply for the electrode of the metal air battery, or for the electrolysis of the catalyst.

### BRIEF DESCRIPTION OF THE DRAWINGS

No drawings

### DETAILED DESCRIPTION

Unless otherwise defined herein, scientific and technical terminologies employed in the present disclosure have the meanings that are commonly understood and used by one of ordinary skill in the art.

The following describes the embodiment of the present disclosure by specific embodiments, and those with general knowledge in the related technical field may easily understand the advantages and efficacy of the present disclosure from the content disclosed in this specification. The present disclosure may also be implemented or applied by other different embodiments, and the details in this specification may also be based on different views and applications, and may be modified and changed without deviating from the ideas disclosed in the present disclosure.

The phrase “comprise/comprising/contain/containing,” or “have/having/has” specific components described herein, unless otherwise explained, may include other components such as elements, regions, portions, or steps, etc., rather than excluding those other elements. In addition, unless otherwise clear explanation, the singular forms “a/an” and “the” used herein include plural forms, and the phrases “or,” “and/or” and “/” used herein are interchangeable.

The numeral ranges used herein are inclusive and combinable, any numeral value that falls within the numeral scope herein could be taken as a maximum or minimum value to derive the sub-ranges therefrom. For example, it should be understood that the numeral range “from 30° C. to 50° C.” comprises any sub-ranges between the minimum value of 30° C. to the maximum value of 50° C., such as the sub-ranges from 30° C. to 40° C., from 40° C. to 50° C., and from 35° C. to 45° C.

Some specific embodiments of the present disclosure are further illustrated in detail through the following examples and comparative examples.

### Example 1

582 mg of Co(NO₃)₂·6H₂O (brought by J. T. Baker, 99% of purity), 502 mg of Mn(NO₃)₂·4H₂O (brought by Alfa Aesar, 98.5% of purity), and 582 mg of Ni(NO₃)₂·6H₂O (brought by Alfa Aesar, 98.5% of purity) were added into 40 ml of deionized water (DIW), and 0.5 g of cetyltrimethylammonium bromide (CTAB) surfactant was added at the same time, then stirring by the magnetic stirring bar for 40 minutes until the mixed solution appeared to be homogenous; wherein Co, Mn, and Ni elements are all 2 mmol. Then, 2.16 g of 30 mmol of urea was added and stirred by the magnetic stirring bar for 40 minutes until the urea was completely dissolved. The mixed solution was added into the altoclave and was placed in the 140° C. oven for 5 hrs. Later, the mixed solution was centrifuged and washed by the DIW and ethanol twice, respectively, to obtained a filtrate. The filtrate was dried for 12 hrs by vacuum oven after filtration in the vacuum filter. The dried filtrate was placed in the muffle furnace and heated in the air atmosphere of 500° C. for 2 hours to prepare the CoMnNi oxide powder with an average surface area of 1.5×10⁸ nm 2 of a single particle and numbered CMN.

210 g of the oxide powder and 260 mg of polymethylmethacrylate (PMMA) (brought by Acros (Thermo), 99% of purity) were mixed and then the 5 ml of dimethylformamide (DMF) (brought by Sigma Aldrich, 99.8% of purity) was added, then stirring by the magnetic stirring bar for 24 hrs to prepare electrospinning precursor solution of PMMA-free particles and uniformly distributed oxide powder. 5 ml of electrospinning precursor solution was added into a syringe with 22 G needle head, and the aluminum foil plate was wiped by the acetone. Then, electrospinning equipment was set and a positive electrode of the power supply was connected to the needle head, and the negative electrode of the power supply was connected to aluminum foil plate. The electrospinning equipment was adjusted to an applied voltage of 15 kV, a flow rate of supplied electrospinning precursor solution of 2.5 ml/hr, and a working distance of 10 cm between needle head and aluminum foil plate.

During the electrospinning process, the electrospinning precursor solution will form a charge-covered conical drip of Taylor cone within the needle head at the additional 15 kV of electric field. The repulsive force produced by the charge of the drips overcomes the surface tension allowing the drips to be elongated and the large particles of oxide gathering to be dispersed at the same time, thereby injecting the oxide-containing fluid stream toward the aluminum foil plate. The liquid of the fluid stream will be evaporated during the injection, allowing current to be converted into the movement of the charge on the surface of the fiber. The electrostatic repulsion at bends of the fiber cause the fiber to be constantly swinging, which allows the fiber to be elongated and eventually extended to nano-scale and adsorbed to aluminum foil plate, and thereby obtained CrMnNi alloy oxide-containing nanofiber sample.

Nanofiber sample-adsorbing aluminum foil plate was placed at the vacuum oven overnight, and then the nanofiber sample was removed from the aluminum foil plate, placed in the muffle furnace for conducting annealing treatment at 450° C. in the air atmosphere for 2 hrs to obtained a catalyst containing a CrMnNi alloy oxide core and a carbon layer coating on a surface of the CrMnNi alloy oxide core. The code number of prepared catalyst is CMN-P-S-450, and the average surface area of a single particle of which is 7×10³ nm².

### Example 2

Example 2 is similar to the process of Example 1, except that Example 2 adjusted the amount of Co(NO₃)₂·6H₂O, Mn(NO₃)₂·4H₂O, and Ni(NO₃)₂·6H₂O, so that the mole number of Co, Mn, and Ni elements in the CoMnNi oxide powder are 3 mmol, 1 5 mmol, and 1.5 mmol, respectively. The code number of prepared catalyst is C2MN-P-S-450.

### Example 3

Example 3 is similar to the process of Example 1, except that Fe(NO₃)₃·9H₂O (brought by J. T. Baker, 99% of purity) was further added to DIW to prepare CoMnNiFe oxide powder, and the amount of Co(NO₃)₂·6H₂O, Mn(NO₃)₂·4H₂O, Ni(NO₃)₂·6H₂O, and Fe(NO₃)₃·9H₂O were adjusted, so that the mole number of Co, Mn, Ni, and Fe were all 1.5 mmol in Example 3. The code number of prepared catalyst is CMNF-P-S-450.

### Example 4

Example 4 is similar to the process of Example 1, except that Cr(NO₃)₂·9H₂O (brought by Alfa Aesar, 98.5% of purity) was further added to DIW to prepare CoMnNiCr oxide powder, and the amount of Co(NO₃)₂·6H₂O, Mn(NO₃)₂·4H₂O, Ni(NO₃)₂·6H₂O, and Cr(NO₃)₂·9H₂O were adjusted, so that the mole number of Co, Mn, Ni, and Cr were all 1 5 mmol in Example 4. The code number of prepared catalyst is CMNCr-P-S-450.

### Example 5

Example 5 is similar to the process of Example 1, except that Cu(NO₃)₂·2.5H₂O (brought by J. T. Baker, 99% of purity) was further added to DIW to prepare CoMnNiCu oxide powder, and the amount of Co(NO₃)₂·6H₂O, Mn(NO₃)₂·4H₂O, Ni(NO₃)₂·6H₂O, and Cu(NO₃)₂·2.5H₂O were adjusted, so that the mole number of Co, Mn, Ni, and Cu were all 1.5 mmol in Example 5.

### Example 6

Example 6 is similar to the process of Example 1, except that TiCl₃ (brought by Sigma Aldrich, 12% of purity) was further added to DIW to prepare CoMnNiTi oxide powder, and the amount of Co(NO₃)₂·6H₂O, Mn(NO₃)₂·4H₂O, Ni(NO₃)₂·6H₂O, and TiCl₃ were adjusted, so that the mole number of Co, Mn, Ni, and Ti were all 1 5 mmol in Example 6.

### Example 7

Example 7 is similar to the process of Example 1, except that Fe(NO₃)₃·9H₂O and Cr(NO₃)₂·9H₂O were further dissolved in the DIW to prepare CoMnNiFeCr oxide powder, and the amount of Co(NO₃)₂·6H₂O, Mn(NO₃)₂·4H₂O, Ni(NO₃)₂·6H₂O, Fe(NO₃)₃·9H₂O, and Cr(NO₃)₂·9H₂O were adjusted, so that the mole number of Co, Mn, Ni, Fe, and Cr were all 1.2 mmol in Example 7.

### Comparative Example 1

2 mg of oxide powder of code number CMN in the Example 1 and carbon black were added to 245 μl of DIW in a molar ratio of 3:7, and 245 μl of ethanol and 10 μ1 of perfluorosulphonic acid (nafion) were added at the same time. and ultrasonic oscillated for about 1 hr until the mixed solution was in a homogenous state, then placed in the muffle furnace for conducting annealing treatment at 450° C. in an air atmosphere for 2 hra to prepare code number CMN-450+S of oxide powder as a catalyst.

### Comparative Example 2

Comparative example 2 is similar to the process of Example 1, except that the oxide powder was not placed in the muffle furnace for oxidation treatment in the Comparative example 2. The code number of prepared catalyst is CMN-OH.

### Comparative Example 3

Comparative example 3 is similar to the process of Example 1, except that the nanofiber sample was subjected to a high temperature annealing treatment under 800° C. for 2 hrs in the Argon (Ar) atmosphere in the Comparative example 3. The code number of prepared catalyst is CMN-OH-S-800Ar.

### Test Approach

Electrochemical analysis was performed on each catalyst described above in the examples and comparative examples by using an electrochemical workstation with a built-in electrochemical impedance spectroscopy (EIS), model number Muti Autolab/M204, to measure the overpotential E_{η10} and E_{1/2} of OER and ORR respectively and calculate the difference ΔE(E_{η10}-E_{1/2}) thereof for evaluating the indicator of the OER/ORR dual-function activity. The lower the ΔE indicating the better OER/ORR dual-function activity. The results of measurement and calculation of electrochemical analysis described above are shown in Table 1.

TABLE 1

| | | OER | | ORR | | |
|---|---|---|---|---|---|---|
| | | Starting | | Starting | | |
| | | value | E_{η10} | value | E_{1/2} | ΔE |
| | Code number | (V) | (V) | (V) | (V) | (V) |
| Example 1 | CMN-P-S-450 | 1.525 | 1.693 | 0.934 | 0.695 | 0.998 |
| Example 2 | C2MN-P-S-450 | 1.545 | 1.778 | 0.924 | 0.613 | 1.165 |
| Example 3 | CMNF-P-S-450 | 1.543 | 1.676 | 0.918 | 0.583 | 1.094 |
| Example 4 | CMNCr-P-S-450 | 1.537 | 1.638 | 0.750 | 0.453 | 1.185 |
| Comparative | CMN-450 + C | 1.609 | 1.820 | 0.875 | 0.587 | 1.233 |
| example 1 | | | | | | |
| Comparative | CMN-OH | 1.569 | 1.728 | 0.904 | 0.509 | 1.218 |
| example 2 | | | | | | |
| Comparative | CMN-OH-S- | 1.642 | N/A | 0.917 | 0.533 | N/A |
| example 3 | 800Ar | | | | | |

Note:
N/A indicates not examinable

Based on the results in Table 1, it has been known that the catalyst of the present disclosure, which is prepared by using the electrospinning process and the acrylic resin and subjected to oxidation treatment with low temperature annealing treatment in the air atmosphere, has a ΔE value lower than 1.2 V, compared to the catalyst prepared by conventional process and carbon black materials, the catalyst prepared by electrospinning process without pre-oxidation treatment, and the catalyst prepared by high temperature annealing treatment in the inert gas such as Ar atmosphere, thereby the catalyst of the present disclosure has an excellent dual-function activity of OER/ORR.

What is claimed is:

1. A catalyst used for oxygen evolution reaction/oxygen reduction reaction, comprising:
an alloy oxide core having a particle size of 30 to 40 nm; and
a carbon layer coated on a surface of the alloy oxide core and having a thickness of 1 to 7 nm,
wherein the alloy oxide is a ternary to quinary alloy oxide comprising a transition metal element.

2. The catalyst according to claim 1, wherein the ternary to quinary alloy oxide is represented by any one of formula (I) to formula (III):
CoMnNi formula (I),
Wherein in formula (I), a molar ratio of Co:Mn:Ni is 1 to 2:1 to 2:1 to 2;
CoMnNiM¹ formula (II),
Wherein in formula (II), M¹ is selected from a group consisting of Fe, Cr, Cu, and Ti,
a molar ratio of Co:Mn:Ni:M¹ is 1 to 2:1 to 2:1 to 2:1 to 2; and
CoMnNiM²M³ formula (M),
Wherein in formula (III), any one of the M² and M³ is selected from a group consisting of Fe, Cr, Cu, and Ti, and M² and M³ are different from each other, and
a molar ratio of Co:Mn:Ni:M²: M³ is 1 to 2:1 to 2:1 to 2:1 to 2, 1 to 2.

3. The catalyst according to claim 2, wherein a molar ratio of CoMnNi of the alloy oxide core to C of carbon layer is 90:10 to 60:40.

4. The catalyst according to claim 1, which has a surface area of 6500 to 9500 nm².

5. A method of preparing a catalyst for oxygen evolution reaction/oxygen reduction reaction, comprising:
mixing and stirring three to five different metal sources and a surfactant in water to form a mixture;
oxidizing the mixture in an air atmosphere to obtain an alloy oxide;
mixing and stirring the alloy oxide and an acrylic resin in a solvent to obtain an electrospinning precursor solution;
subjecting the electrospinning precursor solution to an electrospinning process to obtain alloy oxide-containing nanofibers; and
annealing the alloy oxide-containing nanofibers in an air atmosphere to obtain the catalyst.

6. The method according to claim 5, wherein the surfactant is cetyltrimethylammonium bromide, the acrylic resin is selected from a group consisting of polymethylmethacrylate, poly(ethyl methacrylate), and poly(butyl methacrylate), and the solvent is dimethylformamide.

7. The method according to claim 5, wherein the mixture is oxidized at 450 to 550° C. for 1.5 to 2.5 hr.

8. The method according to claim 5, wherein the alloy oxide-containing nanofibers are annealed at 420 to 480° C. for 1.5 to 2.5 hr.

9. The method according to claim 5, wherein each of the metal sources comprises a transition metal element which is selected from a group consisting of Co, Mn, Ni, Fe, Cr, Cu, and Ti.

10. The method according to claim 5, wherein the alloy oxide-containing nanofibers are obtained by the electrospinning process using an electrospinning equipment under the process conditions of 15 kV applied voltage, 2.5 ml/hr flow rate, 10 cm working distance, and 22 G needle head.
